(19) United States
(12) Patent Application Publication
(10) Pub. No.: US 2012/0084772 A1
(43) Pub. Date: Apr. 5, 2012

(54) METHOD AND SYSTEM FOR DEPLOYING APPLICATION COMPONENTS IN A PARTIAL DEPLOYMENT

(76) Inventors: Tomer Shadi, Yehud (IL); Nadav Fischer, Yehud (IL); Dimitry Lifman, Yehud (IL)

(21) Appl. No.: 12/897,678

(22) Filed: Oct. 4, 2010

(51) Int. Cl. G06F 9/445

(52) U.S. Cl. 717/177

(57) ABSTRACT

A method is provided for deploying an application component in a multi-component deployment configuration. An application component and integration topology is acquired for a multi-component deployment configuration. An additional application component is selected. A predefined integration is enabled associating the additional application component with a deployed application component in the application component and integration topology. The additional application component and the predefined integration are deployed on to a target machine.

### BACKGROUND

Many computer and networking systems use a plurality of hardware devices and plurality of software applications running on the hardware devices. The software applications may be produced by different or independent software development groups. One software application may have the capability to interact with another software application and use the functions of the other software application. The process of installing the software applications on the hardware devices may be called deployment of a multi-component system.

Clients may request a customized configuration of software applications and hardware devices. Creating the interactions and functions between software applications, called integrations, and deploying the software applications may be a labor intensive process performed manually by a number of skilled on-site engineers with specific expertise in the software applications or the application components. The manual deployment may be performed for each client's customized configuration. Such customized integrations may take time to develop and the deployment may be error prone. The manual deployment may also involve the complex management of virtual appliances and may not cover possible deployment variants.

Application components may be deployed at different times or project phases relative to the deployment of other application components. Clients may upgrade or expand the capacity of a system by replacing or adding additional application components or hardware devices. Some application components may also be added and deployed some time after the initial application components have been running in the client's system.

### BRIEF DESCRIPTION OF THE DRAWINGS

FIG. 1A is an illustration of an application component and integration topology for a multi-component deployment configuration in accordance with an embodiment;

FIG. 1B is an illustration of selecting an additional application component in an application component and integration topology for a multi-component deployment configuration in accordance with an embodiment;

FIG. 1C is an illustration of enabling a predefined integration in an application component and integration topology for a multi-component deployment configuration in accordance with an embodiment;

FIG. 2A is an illustration of an application component and integration topology for a multi-component deployment configuration in accordance with an embodiment;

FIG. 2B is an illustration of selecting an application component to be removed in an application component and integration topology for a multi-component deployment configuration in accordance with an embodiment;

FIG. 2C is an illustration of disabling a predefined integration in an application component and integration topology for a multi-component deployment configuration in accordance with an embodiment;

FIG. 3 is an illustration of a system for deploying additional application components including a user device, a deployment server, and target machines in accordance with an embodiment;

FIG. 4A is an illustration of a system for deploying additional application components including application components, a deployment server, and target machines in accordance with an embodiment;

FIG. 4B is an illustration of a system for deploying additional application components including an additional application component, application components, a deployment server, and target machines in accordance with an embodiment;

FIG. 5 is a flowchart illustrating a method for deploying an additional application component and selected an application component to be removed in a multi-component deployment configuration in accordance with an embodiment; and

FIG. 6 is a flowchart illustrating a method for deploying an additional application component in a multi-component deployment configuration in accordance with an embodiment.

### DETAILED DESCRIPTION

Alterations and further modifications of the features illustrated herein, and additional applications of the principles of the technology as illustrated herein, which would occur to one skilled in the relevant art and having possession of this disclosure, are to be considered within the scope of the technology. The same reference numerals in different drawings represent the same element.

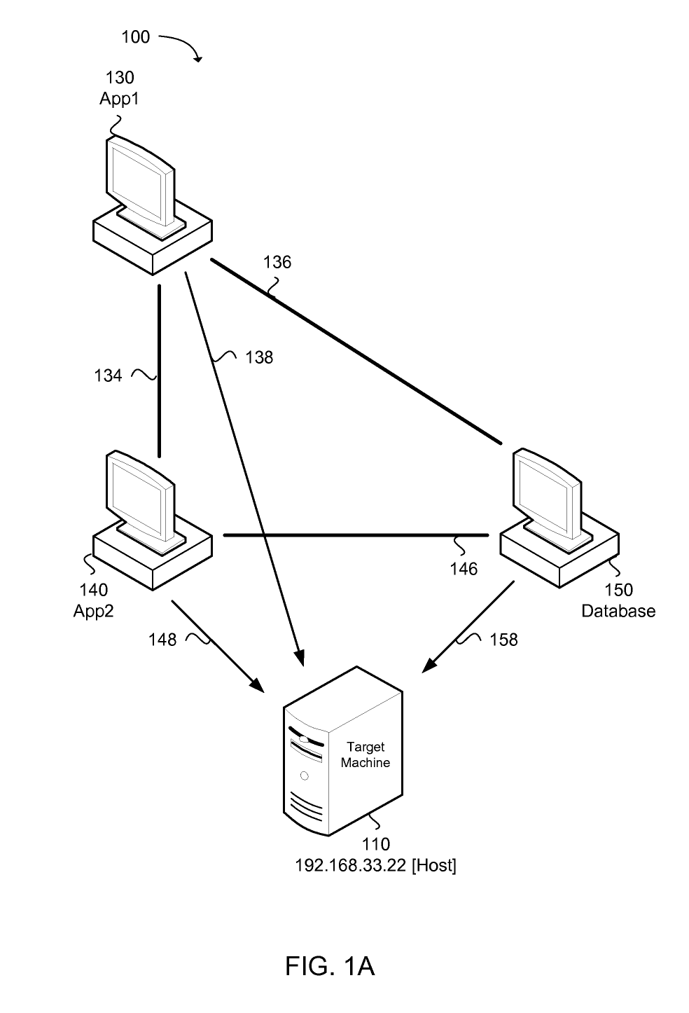

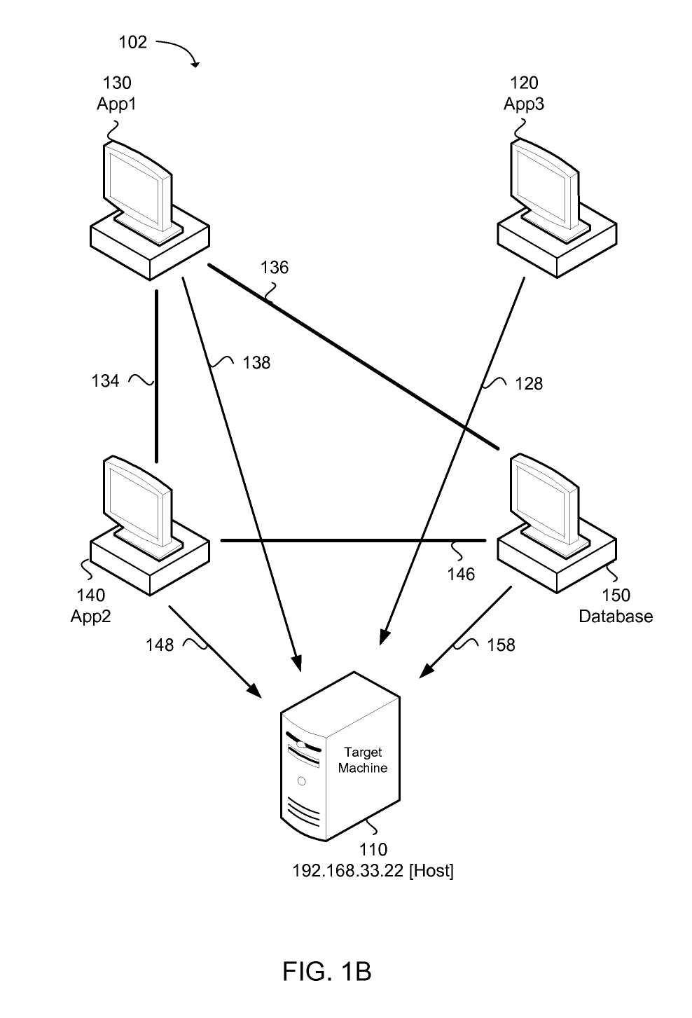

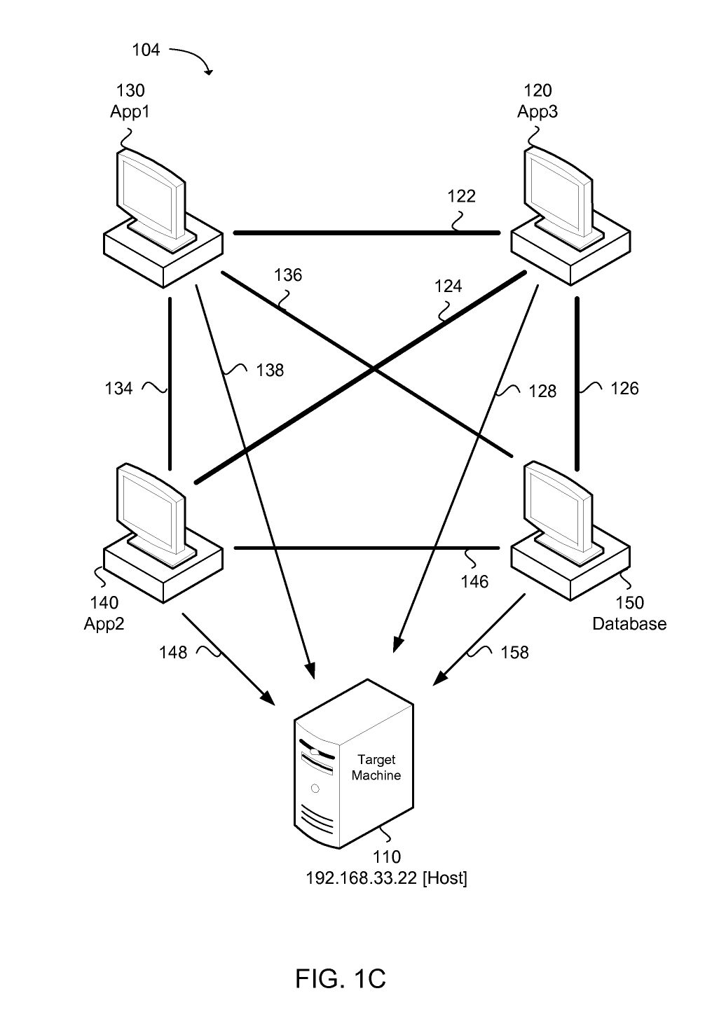

As illustrated in FIG. 1A, a deployment server may acquire an application component and integration topology 100 of a multi-component deployment configuration running on a target machine. A deployment server may include: the application components 130, 140, and 150, the integrations 134, 136, and 146 between the application components, the meta-data instructions or XML file used to deploy the application components and integrations, and the instructions applied after the deployment of the application components and integrations. In addition, the deployment server may also store the management operations for the deployment, the validation of the application components and integration deployment, and the workflow engine to execute the deployment instructions. The deployment server may include a combination of a disk storage device, a processor, and memory. The deployment server may facilitate the deployment of application components and integrations on a target machine 110.

An application component 130, 140, and 150 may be a software application, firmware or combination of software and firmware. A software solution may be a group of software products, software applications, or application components and integrations delivered as a single package. For example, an application component may be a Service Manager (SM), a Release Control (RC), a Business Service Management (BSM) package, a Configuration Management System (CMS), a Configuration Management Database (CMDB) application, or an Operation Manager Windows (OMW).

An integration 134 may include a definition of functions of a first application component 130 that may be used by a second application component 140, and the integration may include a definition of functions of the second application component that may be utilized by the first application component. An integration may also include authentication or other configuration information needed for the integration to be properly instantiated. The integration 134, 136, or 146 may be a predefined standard set of functions used between two application components that may be defined and usable before the user's or client's system is customized, specified or ordered with specific component applications. The integration may include functions of more than two application components.

The application component and integration topology 100 may include the application components 130, 140, and 150 and the integrations 134, 136, and 146 running on a target machine 110 or plurality of target machines. A deployment may include loading a component application and integrations on to a physical machine or target machine. The topology may provide an indication or graphical representation of the application components loaded 138, 148, and 158 or running on the target machine or a deployment server. The topology may symbolically represent the components and the integrations on the target machine or the components and the integrations to be installed or deployed on the target machine with a user interface (UI). The topology may be displayed to a user graphically using a graphical user interface (GUI). The operations that may be applied in relation to the topology may also include the application of meta-data instructions, applying validation tests and instructions, applying a workflow sequence for ordering the application components, creation of the integrations, and performing the validations of the application components and integrations on the target machine to ensure an adequate or proper deployment.

The method for deploying an application component in multi-component deployment configuration may include acquiring an application component and integration topology 100 from the target machine 110, a deployment server, or a system device. The topology may include predefined solutions with a plurality of application components and their associated integrations. The acquired application components and integrations in the topology may be deployed and running on the target machine when the topology is acquired. The system may identify the deployed application components and deployed integrations in the topology.

As illustrated in FIG. 1B, a user may select an additional application component 120 to be deployed 128 on the target machine 110 using the UI. The topology 102 may be updated to reflect the additional application component with the deployed application components 130, 140, and 150 and deployed integrations 134, 136, and 146. The additional application component may be designed or configured to run as a stand alone product or may be an independently developed product configured to run with other independently developed products. The additional application component may be an application on the target machine that operates independently of the other deployed application components or operates independently of the available application components on the deployment server. The additional application component may be configured to be deployed as a separate package or product from the deployed application components.

As illustrated in FIG. 1C, the selection of the additional application component may automatically enable a predefined integration 122, 124, or 126 that associates the functions of the additional application component 120 with a deployed application component 130, 140, or 150 already in the topology 104. The user may select or deselect the predefined integrations to customize the user's system to the user's specifications. Deselecting the predefined integrations will disable the predefined integration from the topology. The method may enable a set of predefined integration for the additional application component associated with deployed application components or enabled application components.

The desired system capabilities for the additional application component or predefined integration may be checked against the capabilities of the target machine. The desired system capabilities may include memory constraints, disk space constraints, or supported operating system. The target machine capability may include the amount of memory, available disk space, and supported operating system.

The additional application component 120 and predefined integration 122, 124, or 126 may be deployed 128 onto a target machine 110. The additional application component may be deployed with other application components enabled in the topology where the enabled component application or the related integrations are not yet deployed. The deployment of the additional application component, the enabled application components, the predefined integrations, or the enabled integrations may be validated to ensure an adequate or proper deployment on the target machine.

Checking the desired system capabilities and verifying the target machines capability for hosting the additional application component and the enabled component applications may be performed in parallel. The additional application component and enabled application components may be deployed and validated in parallel with each other onto the target machine. Alternatively, checking the desired system capabilities and verifying the target machines capability for the predefined integration and the enabled integrations may be performed in series where one integration may be checked and verified before another integration may be checked and verified. The predefined integration and the enabled integrations may be deployed in series on to the target machine. The predefined integration and the enabled integrations may be validated in series.

The additional application component, the enabled component applications, the predefined integration, and the enabled integrations may be deployed using a workflow scripting to sequence and prioritize the install order of the application components and integrations. The component applications may be deployed before the integrations are deployed. The topology configuration or multi-component deployment configuration may be updated with the additional application component and the predefined integration on the deployment server or the user device. The topology configuration may be stored on the user device or the deployment server.

For example, a target machine 110 may execute a solution with App1 130, App2 140, and Database 150 component applications with an App1-App2 integration 134, an App1-Database integration 136, and a App2-Database integration 146. The user device or deployment server may acquire the existing topology of the target machine's component applications and integrations. In addition, the existing topology may be acquired from a topology saved on the user device or deployment server from a prior deployment on the target machine. The user may select another application component App3 120 to add to the system configuration and topology. The desired system capabilities of the application component may be checked and compared with the desired system capabilities and availability of the target machine to ensure compatibility on the target machine and any storage requirements for the App3 application component on the target machine. When the App3 is selected, the App3-App1 integration 122, the App3-App2 124, and App3-Database integration 126 may be enabled in the topology for deployment on the target machine. The user may disable the automatically enabled App3-App1 integration, App3-App2, or App3-Database integration before deployment. The App3 application component may be deployed onto the target machine, and then each of the integrations may be deployed to the target machine. The App3 application component, the App3-App1 integration, the App3-App2, and App3-Database integration may be validated with tests to verify that the installation or deployment of the App3 application component and the integrations were properly deployed and that the App3 application component and associated integrations run adequately on the target machine or in the entire system.

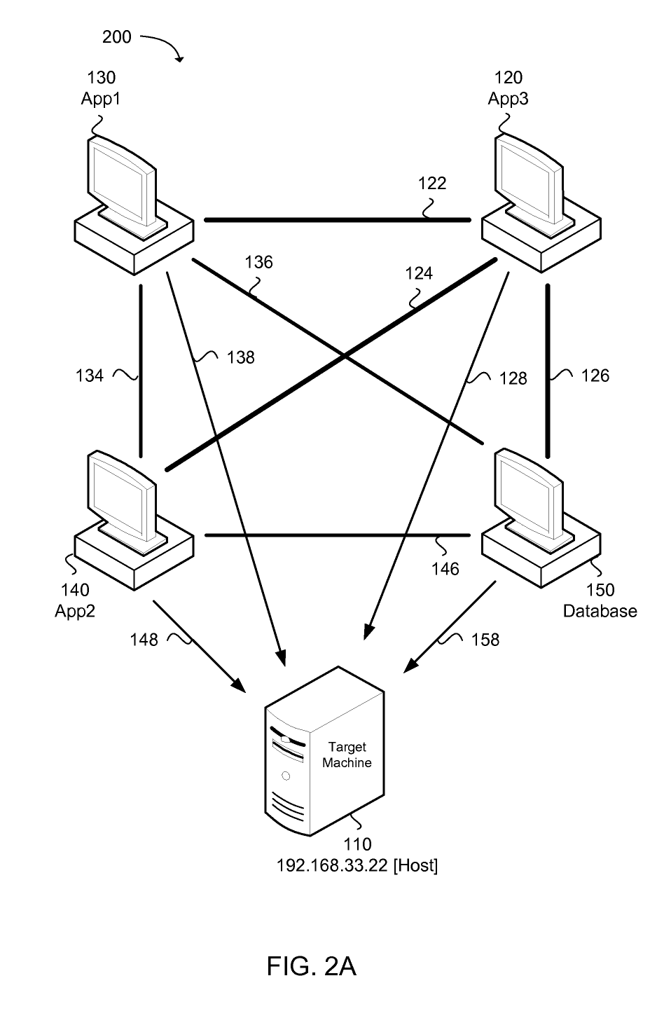

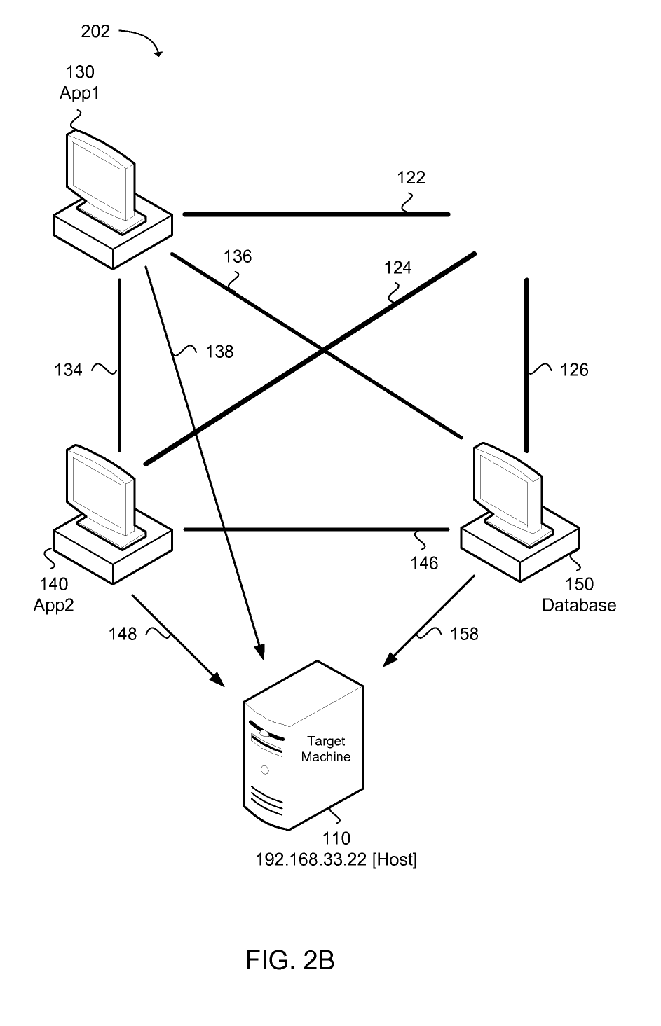

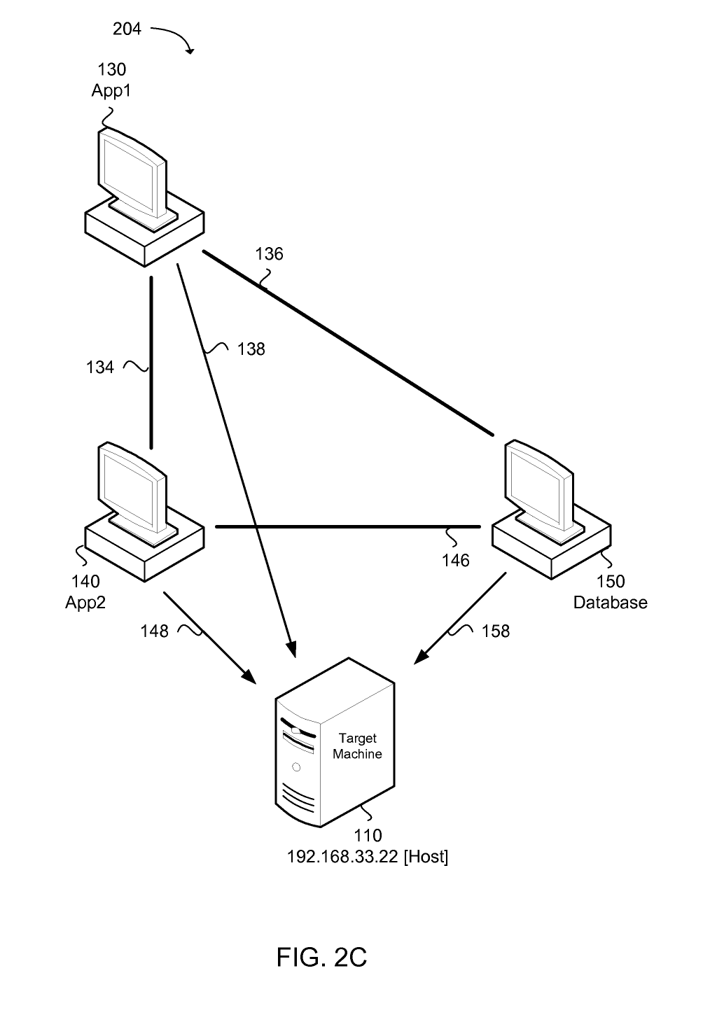

In another embodiment as illustrated in FIG. 2A, an application component may be removed from an integration topology 200 of a multi-component configuration. The application component and integration topology may be acquired for the application components 120, 130, 140, and 150 and the integrations 122, 124, 126, 134, 136, and 146 running on the target machine 110. The deployment server or user device may determine the deployed application components and integrations running on the target machine. An application component 120 to be removed may be selected in the topology.

As illustrated in FIG. 2B, the application to be removed may be disabled from the topology 202. The predefined integrations 122, 124, or 126 associated with the application component to be removed and a deployed application component 130, 140, or 150 may be disabled on the topology when the application component is disabled, as illustrated in FIG. 2C. The selection of the application to be removed may remove the associated integrations automatically. The disabled application component and disabled predefined integration may then be removed from the target machine. The removal of the disabled application component and disabled predefined integration from the target machine may be validated or verified. The deployed application components or deployed integrations remaining on the target machine may be verified to ensure the deployed application components or deployed integrations were not corrupted during the removal of the disabled application component and disabled predefined integration. The disabled application component and disabled predefined integration may be removed from the topology on the deployment server or user device. Removing the application component may include deploying enabled application components and enabled integrations onto the target machines. Enabled application components and enabled integrations may be enabled in the topology along with the additional application component on the deployment server or user device but not yet deployed on the target machine. Once enabled application components and enabled integrations may be deployed on a target machine the enabled application components and enabled integrations may be called deployed application components and deployed integrations.

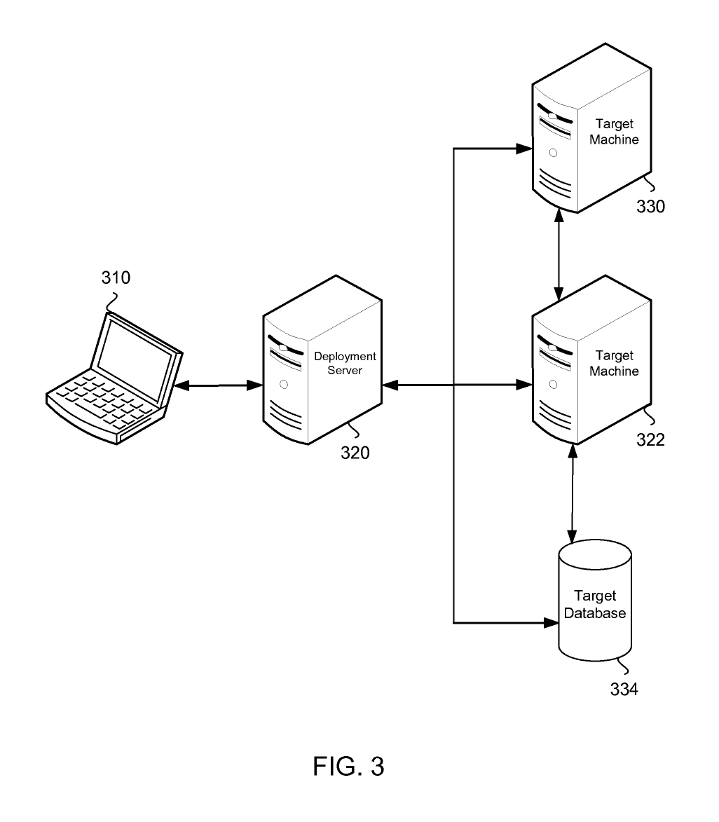

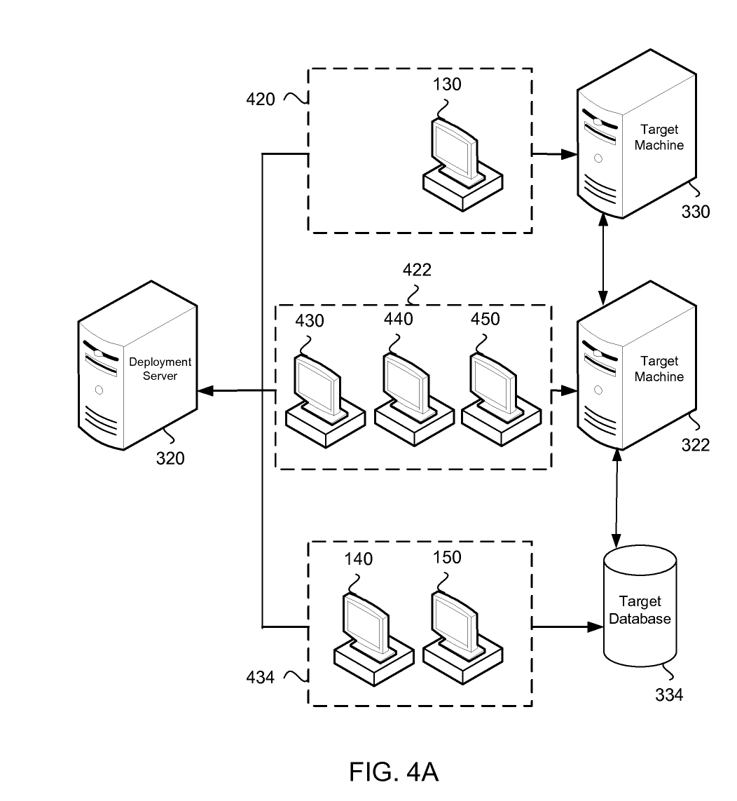

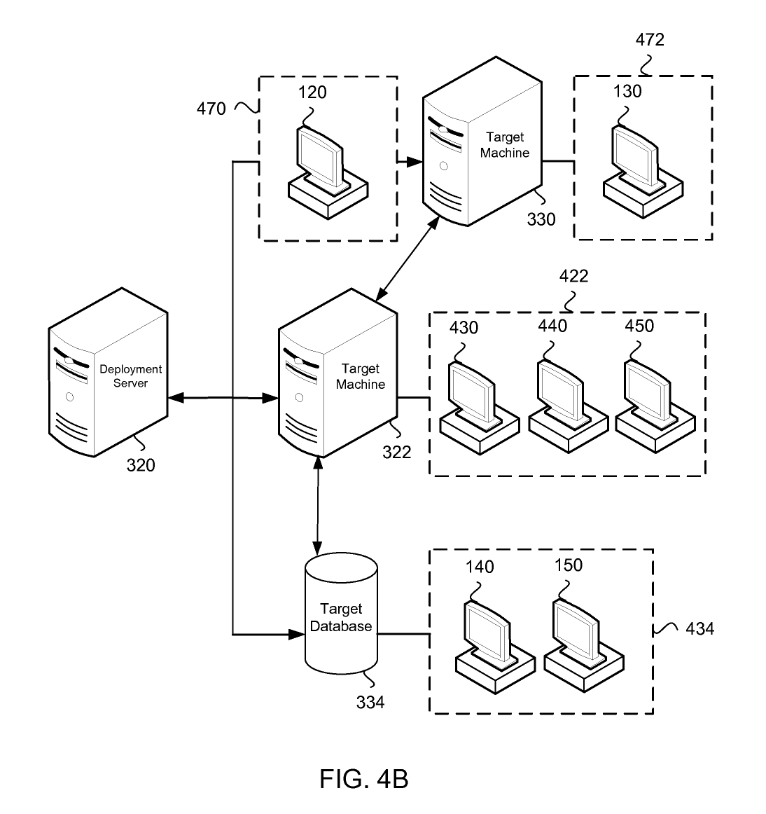

In another configuration as illustrated in FIG. 3, a system for deploying an additional component in a multi-component deployment may include target machines 330 or 322, a target database 334, a user device 310, or deployment server 320. As illustrated in FIG. 4A, application components 130, 430, 440, 450, 140, and 150 may have been deployed onto the target machines 110 and 322 and the target database 234 from the deployment server 320. A first application component 130 may be running as a first solution 420 on a first target machine 110. A second application component 140 and a third application component 150 may be running as a second solution 422 on the target database. A fourth application component 430, a fifth application component 440, and a sixth application component 450 may be running as a third solution on a second target machine 322.

The deployment server 320 may acquire the existing topology from the target machines and/or target database on a target database server. A deployment processor on the deployment server may determine the deployed application components and deployed integration in the topology for the target machines or system.

As illustrated in FIG. 4B, the user device may select the additional application component 120 from a group of available application components on the deployment server or accessible to the deployment server. The additional component may be included in a fourth solution 470. The deployment processor may enable a predefined integration that associates the additional application component with a deployed application component running on the target machines. The enabled predefined integration may be selected from a group of available integration components on the deployment server or accessible to the deployment server. The deployment processor may deploy the additional component and the predefined integration to the first target machine 110. The deployment process may validate the deployment of the additional component and the predefined integration on the first target machine. The system may include a Solution Definition Repository (SDR) that contains the entity definitions used for the component application and integration deployments. The SDR may provide standardizations between component applications and integrations.

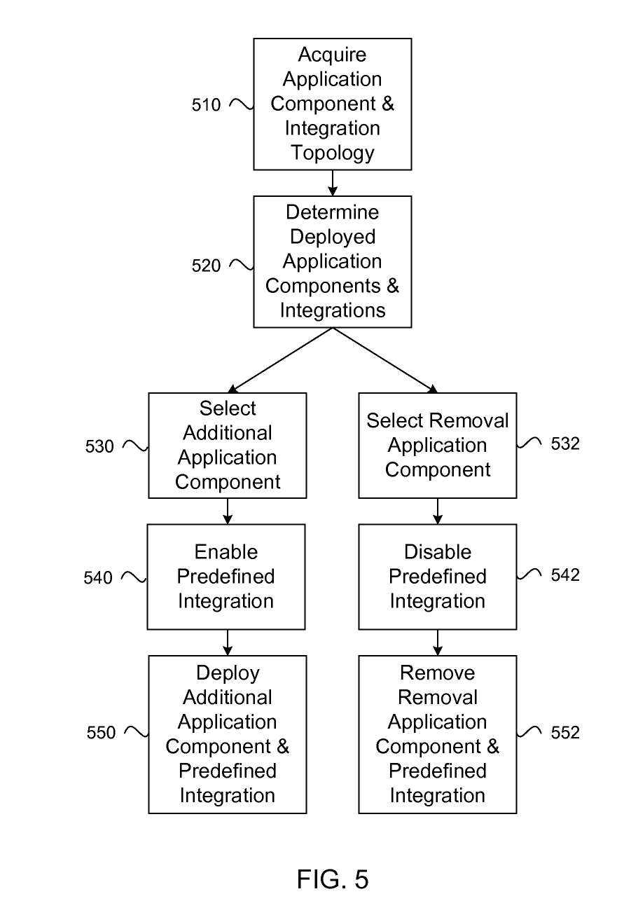

Another configuration is illustrated in the flowchart in FIG. 5, an application component and integration topology may be acquired from a target machine 510. Deployed application components and integrations may be identified 520. An additional application component may be selected 530. Then, a predefined integration associated with the additional application component and the deployed application components may be enabled 540. The additional application component and predefined integration may be deployed on to the target machine 550. In another embodiment, selecting an application component to be removed 532 may follow identifying the deployed application components and integrations 520. Then, the predefined integration associated with the application component to be removed and the deployed application components may be disabled 542. The application component to be removed and the predefined integration may be removed from the target machine 552.

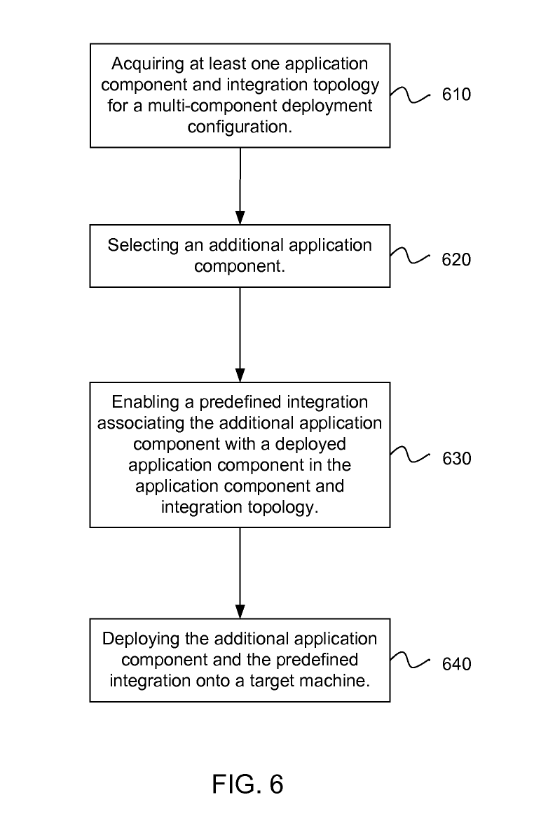

Another embodiment provides a method for deploying an additional application component in a multi-component deployment configuration, as shown in the flow chart in FIG. 6. The method includes the operation of acquiring 610 at least one application component and integration topology for a multi-component deployment configuration. The operation of selecting 620 an additional application component may follow. The next operation of the method may be enabling 630 a predefined integration associating the additional application component with a deployed application component in the application component and integration topology. The method further includes deploying 640 the additional application component and the predefined integration onto a target machine.

The method and system may simplify the deployment of the variants of multi-component systems, which can be beneficial when the structure of multi-component systems change frequently. The method and system may allow for dynamic system deployment and reduce the time and fragility of the deployment process. The method and system may enable the automation of deployment, increase the flexibility of deployment, and reduce the complexity and risk of deployments of multi-component systems.

The method and system for deploying an additional application component in a multi-component deployment configuration may be implemented using a computer readable medium having executable code embodied on the medium. The computer readable program code may be configured to provide the functions described in the method. The computer readable medium may be a RAM, EPROM, flash drive, optical drive, magnetic hard drive, or other medium for storing electronic data. Additionally, the method and system for compressing digital discrete node data based on a bit position to reduce overall power consumption of a networked node may be downloaded as a computer program product transferred from a server or remote computer to a requesting or client device by way of machine readable data signals embodied in a carrier wave or other propagation medium.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

What is claimed is:

1. A method for deploying an additional application component in a multi-component deployment configuration, comprising:
acquiring an application component and integration topology for a multi-component deployment configuration;
selecting an additional application component;
enabling a predefined integration associating the additional application component with a deployed application component in the application component and integration topology; and
deploying the additional application component and the predefined integration on to a target machine.

2. The method of claim 1, wherein a user performs the selecting of the additional application component using a user interface (UI).

3. The method of claim 1, further comprising identifying deployed application components and deployed integrations in the application component and integration topology deployed on the target machine after acquiring the application component and integration topology.

4. The method of claim 3, wherein the additional application component is configured to run as an application on the target machine independently of the deployed application components.

5. The method of claim 3, wherein the additional application component is configured to be deployed separately from the deployed application components.

6. The method of claim 3, wherein deploying the additional application component includes deploying enabled application components and enabled integrations on to the target machine, wherein enabled application components and enabled integrations are enabled in the application component and integration topology before being deployed on to the target machine.

7. The method of claim 6, wherein deploying the additional application component, the enabled application components, and the enabled integrations onto the target machine includes using a workflow script to sequence deploying the additional application component, the enabled application components, and the enabled integrations.

8. The method of claim 1, wherein acquiring the application component and integration topology further comprises acquiring the application component and integration topology from the target machine, a user device, or a deployment server.

9. The method of claim 1, wherein enabling a predefined integration further comprises automatically enabling the predefined integration after the additional application component is selected using an integration defined for use with the additional application component and the deployed application component.

10. The method of claim 1, wherein the predefined integration is configured to allow the additional application component to use a function of the existing component and allow the existing component to use a function of the additional application component.

11. The method of claim 1, further comprising updating the application component and integration topology on a deployment server with the additional application component, and the predefined integration after enabling the predefined integration.

12. The method of claim 1, further comprising validating the deployment of the additional application component and the predefined integration on the target machine.

13. The method of claim 1, further comprising checking desired system capabilities for the additional application component in the application component and integration topology after selecting the additional application component, wherein the desired system capabilities include memory constraints, disk space constraints, or supported operating system.

14. The method of claim 1, wherein the additional application component is selected from the group consisting of software, firmware, or combination thereof.

15. A method for removing an application component in a multi-component deployment configuration, comprising:
acquiring an application component and integration topology for a multi-component deployment configuration;
determining deployed application components and deployed integrations in the application component and integration topology deployed on a target machine;
selecting an application component to be removed;
disabling a predefined integration associating the application component to be removed with a deployed application component in the application component and integration topology; and
removing the application component to be removed and the predefined integration from the application component and integration topology.

16. The method of claim 15, further comprising removing the application component to be removed and the predefined integration from the target machine.

17. The method of claim 15, wherein removing the application component to be removed includes deploying enabled application components and enabled integrations on to the target machine, wherein enabled application components and enabled integrations are enabled in the application component and integration topology but not yet deployed on to the target machine.

18. A system for deploying an application component in a multi-component deployment configuration, comprising:
a target machine for executing application components of a multi-component deployment configuration;
a deployment server for acquiring an application component and integration topology for the multi-component deployment configuration;
a user device for selecting an additional application component, wherein the user device communicates with the deployment server;
a deployment processor within the deployment server for determining deployed application components and deployed integrations in the application component and integration topology deployed on a target machine;
wherein the deployment processor enables a predefined integration associating the additional application component with a deployed application component in the application component and integration topology; and
wherein the deployment processor deploys the additional application component and the predefined integration on to a target machine.

19. The system of claim 18, wherein the deployment processor validates the deployment of the additional application component and the predefined integration on the target machine.

20. The system of claim 18, wherein the deployment processor checks the desired system capabilities for the additional application component in the application component and integration topology before deploying the additional application component on the target machine, wherein the desired system capabilities include memory constrains, disk space constrains, or supported operating system.
